(19) United States
(12) Patent Application Publication
(10) Pub. No.: US 2026/0023535 A1
(43) Pub. Date: Jan. 22, 2026

(54) METHOD, APPARATUS, DEVICE AND STORAGE MEDIUM FOR CREATING A WORKFLOW

(71) Applicant: Beijing Zitiao Network Technology Co., Ltd., Beijing (CN)

(72) Inventor: Xuneng Huang, Beijing (CN)

(21) Appl. No.: 18/984,184

(22) Filed: Dec. 17, 2024

(30) Foreign Application Priority Data
Jul. 18, 2024 (CN) 202410968862.7

(51) Int. Cl. G06F 8/34; G06F 3/04842

(52) U.S. Cl. CPC G06F 8/34; G06F 3/04842

(57) ABSTRACT

Embodiments of the disclosure relate to methods, apparatuses, devices and storage mediums for creating a workflow. An example method includes: adding a first node to a node connection graph in response to a received edit operation; obtaining configuration information associated with the first node, the configuration information at least indicating a set of nodes corresponding to a loop process; and creating a target workflow based on the node connection graph to enable a loop execution of a processing procedure corresponding to the set of nodes in response to triggering of the first node during runtime of the target workflow.

### CLAIM OF PRIORITY

This application is a continuation of, and claims priority to China Application No. 202410968862.7, filed Jul. 18, 2024, the contents of which are incorporated herein by reference in their entirety.

### FIELD

Example embodiments of the present disclosure generally relate to the field of computers, and more particularly, to a method, an apparatus, a device, and a computer-readable storage medium for creating a workflow.

### BACKGROUND

With the development of computer technology, one may create and publish various types of applications through some platforms. During the development of applications, the creation and management of a workflow is an important task. For example, a user may indicate the process flow of a request by editing nodes in a workflow.

### SUMMARY

In a first aspect of the present disclosure, a method for creating a workflow is provided. The method comprises: adding a first node to a node connection graph in response to a received edit operation; obtaining configuration information associated with the first node, the configuration information at least indicating a set of nodes corresponding to a loop process; and creating a target workflow based on the node connection graph to enable a loop execution of a processing procedure corresponding to the set of nodes in response to triggering of the first node during runtime of the target workflow.

In a second aspect of the present disclosure, an apparatus for creating a workflow is provided. The apparatus comprises: an addition module configured to add a first node to a node connection graph in response to a received edit operation; an obtaining module configured to obtain configuration information associated with the first node, the configuration information at least indicating a set of nodes corresponding to a loop process; and a creation module configured to create a target workflow based on the node connection graph to enable a loop execution of a processing procedure corresponding to the set of nodes in response to triggering of the first node during runtime of the target workflow.

In a third aspect of the present disclosure, an electronic device is provided. The electronic device comprises at least one processing unit; and at least one memory coupled to the at least one processing unit and storing instructions for execution by the at least one processing unit that, when executed by the at least one processing unit, cause the electronic device to perform the method according to the first aspect.

In a fourth aspect of the present disclosure, a computer readable storage medium is provided. The computer readable storage medium has stored thereon a computer program that, when executed by a processor, implements the method according to the first aspect.

It should be appreciated that what is described in this section is not intended to limit key features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure may be implemented;

FIG. 2 illustrates a flow diagram of an example process of creating a workflow, according to some embodiments of the disclosure;

FIGS. 3A-3D illustrate example interfaces according to some embodiments of the present disclosure;

FIG. 4 illustrates a schematic structural block diagram of an example apparatus for creating a workflow, according to some embodiments of the disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the scope of the present disclosure.

It should be noted that the titles of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “comprise” and the like should be understood as open-ended including, that is, “include but is not limited to”. The term “based on” should be read as “based at least in part on.” The term “one embodiment” or “the embodiment” should be read as “at least one embodiment”. The term “some embodiments” should be understood as “at least some embodiments”. Other explicit and implicit definitions may also be included below. The terms “first”, “second” and the like may refer to different or identical objects. Other explicit and implicit definitions may also be included below.

Embodiments of the present disclosure may relate to data of a user, acquisition and/or use of data, etc., all following respective legal regulations and related regulations. In embodiments of the present disclosure, the collection, acquisition, processing, treatment, forwarding, use, and the like, of the data are all made with user knowledge and confirmation. Accordingly, when implementing the embodiments of the present disclosure, the user should be informed of the types of data or information that may be involved, a usage range, a usage scenario, and the like in an appropriate manner according to relevant legal regulations, and the authorization of the user is obtained. The specific manner of informing and/or authorization may vary according to actual situations and application scenarios, and the scope of the present disclosure is not limited in this aspect.

The solution in the present description and the embodiments, if involves the personal information, is performed on the basis of legitimacy (for example, the consent of the personal information body is obtained, or necessary for fulfillment of a contract, etc.), and is performed only within a predetermined range or a prescribed range. The user's refusal to process personal information other than the necessary information required for the basic function will not affect the user's use of the basic function.

Traditionally, users may quickly create a workflow, for example, by configuring different processing nodes in the workflow. However, during the execution of the workflow, multiple nodes are usually executed in sequence. The developer needs to add corresponding nodes many times to finish the definition of the repeated flow in the workflow, which greatly affects the development efficiency of the workflow.

Embodiments of the present disclosure provide a solution of creating a workflow. The solution comprises: adding a first node to a node connection graph in response to a received edit operation; obtaining configuration information associated with the first node, the configuration information at least indicating a set of nodes corresponding to a loop process; and creating a target workflow based on the node connection graph to enable a loop execution of a processing procedure corresponding to the set of nodes in response to triggering of the first node during runtime of the target workflow.

In this way, embodiments of the present disclosure can define a loop process in a workflow, so as to support the loop execution of one or more nodes that are triggered, thereby improving the development efficiency of the workflow.

Various example implementations of the solution are described in further detail below with reference to the accompanying drawings.

### Example Environment

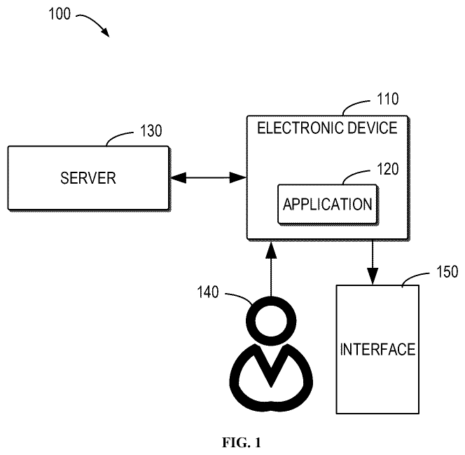

FIG. 1 shows a schematic diagram of an example environment 100 in which embodiments of the present disclosure can be implemented. As shown in FIG. 1, the example environment 100 may comprise an electronic device 110.

In this example environment 100, the electronic device 110 may run an application 120 that supports interface interaction. The application 120 may be any suitable type of application for interface interaction, examples of which may include, but are not limited to, a development application or other suitable application that supports workflow creation. The user 140 may interact with application 120 via the electronic device 110 and/or an attached device thereof.

In the environment 100 of FIG. 1, if the application 120 is active, the electronic device 110 may present an interface 150 for supporting the creation of a workflow through the application 120.

In some embodiments, the electronic device 110 communicates with the server 130 to enable the provision of services to application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination of the foregoing, including accessories and peripherals for these devices, or any combination thereof. In some embodiments, the electronic device 110 can also support any type of interface to a user (such as a “wearable” circuit or the like).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. Server 130 may include, for example, a computing system/server, such as a mainframe, an edge computing node, a computing device in a cloud environment, etc. The server 130 may provide background services for the virtual scene-enabled application 120 in the electronic device 110.

A communication connection may be established between the server 130 and the electronic device 110. The communication connection may be established in a wired manner or a wireless manner. The communication connection may include, but is not limited to, Bluetooth connection, mobile network connection, Universal Serial Bus (USB) connection, Wireless Fidelity (WiFi) connection, and the like, to which embodiments of the present disclosure are not limited. In embodiments of the present disclosure, the server 130 and the electronic device 110 may enable signaling interaction through a communication connection therebetween.

It should be understood that the structure and function of the various elements in environment 100 are described for illustrative purposes only, and are not intended to imply any limitation on the scope of the disclosure.

Some example embodiments of the present disclosure will be described below with continued reference to the accompanying drawings.

### Example Processes

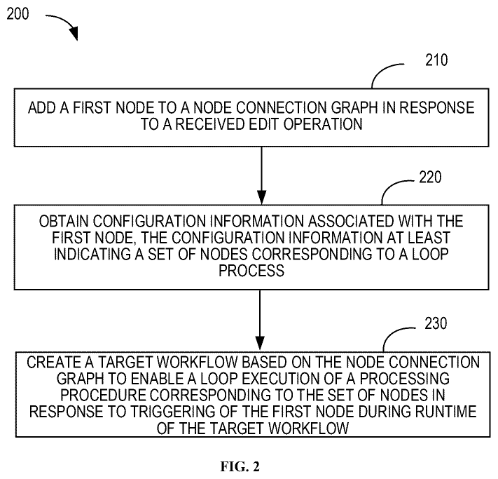

FIG. 2 illustrates a flowchart of a process 200 for creating a workflow, according to some embodiments of the disclosure. In the context of this disclosure, the way of “creating a workflow” may include a variety of forms. For example, a new workflow may be created using the example process 200, or an existing workflow may be opened and edited using an edit interface as described below. The process 200 may be implemented at the electronic device 110. The process 200 is described below with reference to FIG. 1.

As shown in FIG. 2, at block 210, the electronic device 110 adds a first node to the node connection graph in response to the received edit operation.

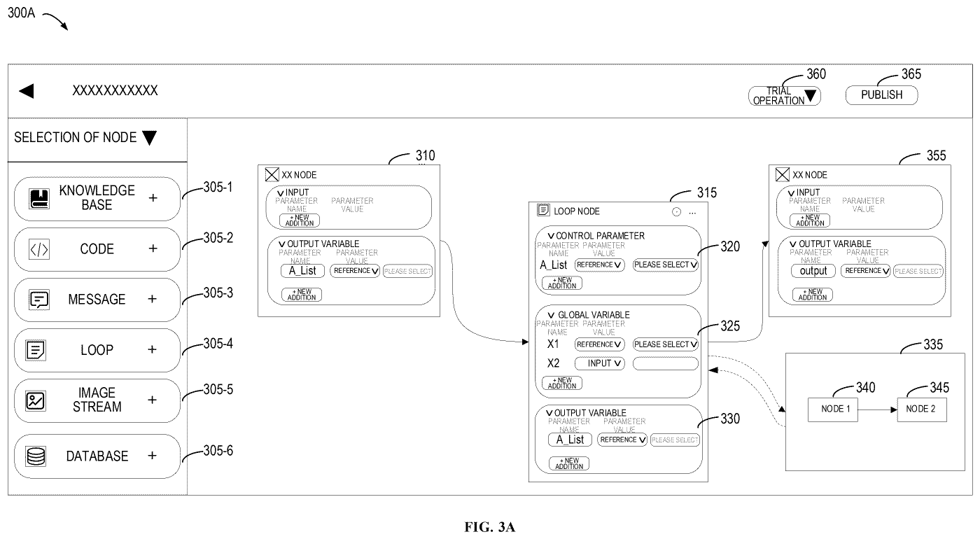

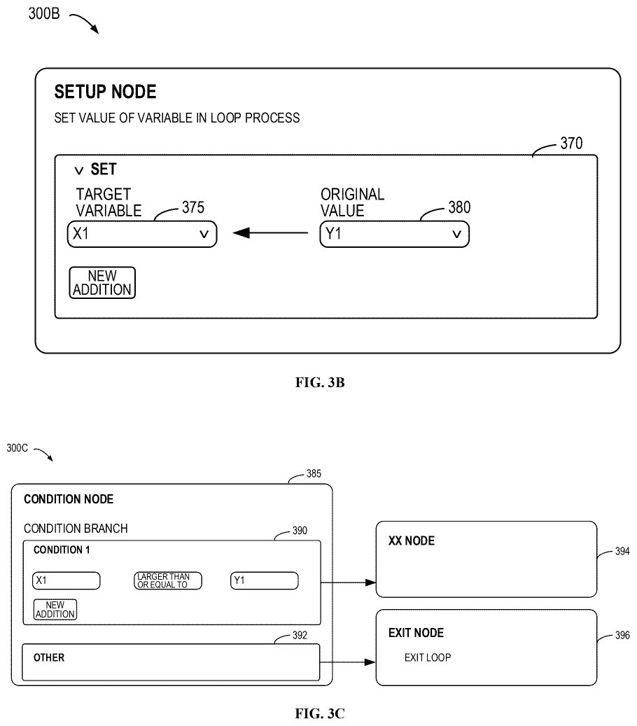

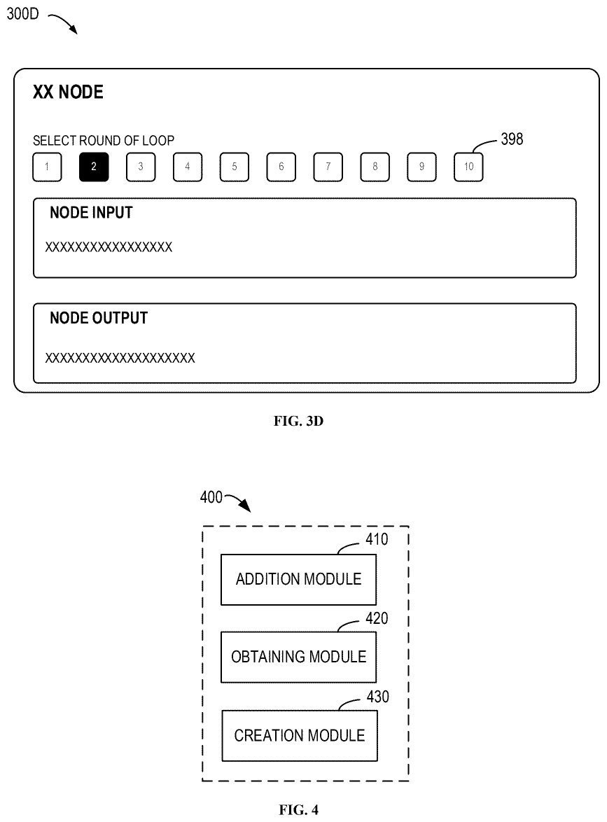

The process 200 will be described below with reference to FIG. 3A, which illustrates an example editing interface 300A in accordance with some embodiments of the present disclosure.

As shown in FIG. 3A, the interface 300A may be a node editing interface for creating a workflow. As shown, the electronic device 110 may present multiple interface elements in interface 300A that correspond to a variety of node types, e.g., interface element 305-1 through interface element 305-6. As examples, the interface element 305-1 may be used to add knowledge base nodes, the interface element 305-2 may be used to add code nodes, the interface element 305-3 may be used to add message nodes, the interface element 305-4 may be used to add loop nodes, the interface element 305-5 may be used to add image stream nodes, and the interface element 305-6 may be used to add database nodes.

In some embodiments, embodiments of the present disclosure may support addition of other suitable types of nodes in addition to the specific nodes above. For example, the electronic device 110 may support the user to add other workflows that have been created as a single processing node into the node connection graph.

As an example, the electronic device 110 may receive the selection of the interface element 305-4 by the user to add a first node 315 to the node connection graph. The first node 315 is also referred to as a loop node for configuring a loop process in a workflow.

At block 220, the electronic device 110 obtains configuration information associated with the first node, and the configuration information indicates at least a set of nodes corresponding to the loop process.

In some embodiments, as shown in FIG. 3A, the electronic device 110 may provide a canvas component 335 associated with the first node 315. The electronic device 110 may configure, via the canvas component 335, one or more nodes associated with the loop process, e.g., node 340 and node 345.

In some embodiments, the electronic device 110 may, for example, receive a user selection of interface elements 305-1 through 305-6 to add one or more nodes in the canvas component 335. Such one or more nodes may indicate the particular process flow of the loop process.

In the present disclosure, a single loop may include performing a processing procedure defined by the canvas component 335 once. In some scenarios, the canvas component 335 may for example include multiple branches. At this time, the nodes corresponding to some branches in the canvas component 335 may not be triggered to execute in a single loop process.

In some embodiments, the electronic device 110 may also configure a loop control parameter associated with the loop process via the first node 315. As shown in FIG. 3A, the first node 315 may be associated with an input control 320 that may be used to configure a loop control parameter to indicate an end condition of the loop process.

In some embodiments, the loop control parameter configured via the input control 320 may include an array object, e.g., “A_List”. Accordingly, the loop process may be controlled based on the array length of the array object (e.g., A_List), so that the loop process can be controlled based on a comparison between the number of loops and the array length. Specifically, when the number of loops reaches the array length, the next loop process will no longer be triggered for execution, and the workflow may proceed to the next node of the loop node 315, e.g., node 355.

In some embodiments, as shown in FIG. 3A, the electronic device 110 may, via the input control 320, reference a second node (e.g., the node 310) associated with the first node 315, thereby configuring an array object (e.g., A_List) associated with the loop process.

In some embodiments, such a second node may comprise any appropriate preceding node of the first node 315, without requiring such a preceding node to be directly connected with the first node 315.

In some embodiments, where the loop control parameter is not configured by the user, the loop process associated with the first node 315 may be triggered to execute in a loop until the exit node is triggered. A specific configuration process of the exit node is described in detail in the following.

Alternatively, where the loop control parameter is not configured by the user, this loop process associated with the first node 315 may be triggered to execute a predetermined number of times and automatically exit the loop, for example.

In some embodiments, the electronic device 110 may also configure a global variable for the loop process via the first node 315. As shown in FIG. 3A, the first node 315 may be associated with an input control 325. The input control 325 may be used to configure one or more global variables. During execution of the loop process, such a global variable may be accessed and/or updated by a set of nodes associated with the loop process.

In some embodiments, as illustrated in FIG. 3A, such a global variable may be defined by referencing a third node (e.g., the node 310) associated with the first node 315. Alternatively, such a global variable may be declared by the input control 325, and the initial value for the global variable may be determined based on user input.

In some embodiments, such a third node may comprise any suitable preceding nodes of the first node 315, without requiring such preceding nodes to be directly connected with the first node 315.

Additionally, the first node 315 may be associated with an input control 330. The input control 330 may be used for the output results of the first node 315. In some embodiments, such output results may be provided to one or more subsequent nodes of the first node 315, without requiring such subsequent nodes to be directly connected to the first node 315.

The specific process of configuring one or more nodes corresponding to the loop process via the canvas component 335 will be described in detail below. In some embodiments, such a canvas component 335 may be expanded, retracted, enlarged, reduced, or moved based on user operation, for example.

In some embodiments, the canvas component 335 may support configuration of one or more nodes specific to the loop process. In some embodiments, as shown in FIG. 3B, the canvas component 335 may support adding setup nodes, for example.

As shown in FIG. 3B, the setup node may comprise an input control 370 for setting a value of a predetermined variable associated with the loop process. For example, the electronic device 110 may specify a variable to be set through the control 375, and may specify a specific value for the variable through the control 380. In some embodiments, the variables set through the control 375 may comprise a global variable associated with loop processes.

Thus, the embodiments of the present disclosure can support dynamically modifying the value of the global variable during the loop process, thereby improving the control flexibility of the loop process.

In some embodiments, the canvas component 335 may also support adding an exit node to trigger exiting the loop process corresponding to the canvas component 335. As shown in FIG. 3C, the input to the exit node 396 may correspond to a condition to exit the loop process.

Taking FIG. 3C as an example, the exit node 396 may be connected to a condition node 385. Accordingly, the condition node 385 may include, for example, one or more branches, e.g., branch 390 and branch 392. Accordingly, the condition node 385 may trigger execution of node 394 when branch 390 is satisfied. Rather, the condition node 385 may trigger exit node 396 when branch 392 is satisfied, thereby exiting the loop process.

With continued reference to FIG. 2, at block 230, the electronic device 110 creates a target workflow based on the node connection graph. Accordingly, during the runtime of the target workflow, in response to the triggering of the first node, a processing procedure corresponding to a set of nodes is performed in a loop.

With continued reference to FIG. 3A, in some embodiments, after the edit of the node connection graph is completed, the electronic device 110 may trigger a corresponding debugging procedure, e.g., based on the control 360. Additionally, the electronic device 110 may create and publish the corresponding target workflow based on the trigger to the control 365.

In some embodiments, during debugging workflow, the electronic device 110 may further display debugging information related to the loop process.

FIG. 3D illustrates a debugging window 300D of a node associated with the loop process. The debugging window 300D may display the debugging information of the first node 315 or a node in the canvas component (e.g., the node 340 or the node 345).

As shown in FIG. 3D, the debugging window 300D may display a plurality of viewing entries 398, each of which may correspond to multiple rounds of the execution, also referred to as multiple rounds of loops or multiple rounds of iterations, of the processing procedure corresponding to the canvas component 335. As shown in FIG. 3D, the processing procedure may include, for example, 10 rounds of execution.

Further, the electronic device 110 may receive a selection of a target viewing entry of the plurality of viewing entries (for example, a selection of a viewing entry corresponding to the second round of the loop), and may accordingly display debugging information associated with the round of execution in the debugging window 300D. For example, the electronic device 110 may correspondingly display debugging information of the node in the process of the second round of loop, for example, input information and output information of the node.

In this way, the embodiments of the present disclosure may further support debugging of the loop process, thereby improving the efficiency of workflow development.

As an example, the electronic device 110 may create a corresponding target workflow based on configuration information for the nodes in the node connection graph and the connections between the nodes. Such a target workflow may for example be published or shared to other users.

In some embodiments, such a target workflow may be published independently, or trigger to create and/or publish an application based on the target workflow, e.g., a bot or an agent.

Accordingly, during the runtime of the target workflow, in response to the triggering of the first node 315, the loop process corresponding to the canvas component 335 may be triggered to be executed. Accordingly, the target workflow may terminate execution of the loop process based on the exit condition of the loop process.

Based on the above described process, the embodiments of the present disclosure can support defining a loop process in a workflow, so as to support that one or more nodes are triggered to be executed in a loop, thereby improving the development efficiency of the workflow.

### Example Apparatus and Device

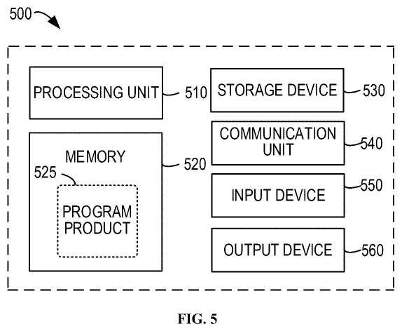

The embodiments of the present disclosure further provide corresponding apparatus for implementing the above methods or processes. FIG. 4 illustrates a schematic structural block diagram of an example apparatus 400 for creating a workflow, according to some embodiments of the present disclosure. The apparatus 400 may be implemented as or included in an electronic device 110. The various modules/components in the apparatus 400 may be implemented in hardware, software, firmware, or any combination thereof.

As shown in FIG. 4, the apparatus 400 comprises: an addition module 410 configured to add a first node to a node connection graph in response to a received edit operation; an obtaining module 420 configured to obtain configuration information associated with the first node, the configuration information at least indicating a set of nodes corresponding to a loop process; and a creation module 430 configured to create a target workflow based on the node connection graph to enable a loop execution of a processing procedure corresponding to the set of nodes in response to triggering of the first node during runtime of the target workflow.

In some embodiments, the addition module 410 is further configured to: add the first node to the node connection graph in response to a selection of a target interface element in a plurality of interface elements, where the target interface element corresponds to a loop node, and the plurality of interface elements corresponds to a plurality of node types.

In some embodiments, the apparatus further comprises a node determination module, which is configured to: present a canvas component associated with the first node; and determine, via the canvas component, the set of nodes corresponding to the loop process.

In some embodiments, the apparatus further comprises a configuration module, which is configured to: configure a loop control parameter associated with the loop process via a first input control associated with the first node, where the loop control parameter indicates an end condition of the loop process.

In some embodiments, the configuration module is further configured to: configure an array object associated with the loop process such that the loop process is associated with a length of the array object.

In some embodiments, the configuration module is further configured to: configure the array object by referencing a second node associated with the first node.

In some embodiments, the configuration module is further configured to: configure a global variable for the loop process via a second input control associated with the first node, where the global variable supports access and/or update by the set of nodes.

In some embodiments, the configuration module is further configured to: configure the global variable via the second input control by referencing a third node associated with the first node; or configure the global variable via the second input control, where an initial value of the global variable is determined based on a user input.

In some embodiments, the set of nodes comprises: a setup node for setting a value of a predetermined variable associated with the loop process; or an exit node for triggering to exit the loop process.

In some embodiments, input information of the exit node indicates a condition to exit the loop process.

In some embodiments, the apparatus 400 further comprises a debugging module configured: receive a request for debugging the target workflow; provide, in association with a target node, a plurality of viewing entries corresponding to a plurality of rounds of execution of the processing procedure, where the target node is the first node or one of the set of nodes; and in response to a selection of a target viewing entry in the plurality of viewing entries, present debugging information associated with a target round of execution of the processing procedure and the target node, where the target round corresponds to the target viewing entry.

FIG. 5 illustrates a block diagram of an electronic device 500 in which one or more embodiments of the present disclosure may be implemented. It should be appreciated that the electronic device 500 shown in FIG. 5 is merely illustrative and should not constitute any limitation on the functionality and scope of the embodiments described herein. The electronic device 500 shown in FIG. 5 may be used to implement the electronic device 110 of FIG. 1.

As shown in FIG. 5, the electronic device 500 is in the form of a general electronic device. The components of the electronic device 500 may comprise, but are not limited to, one or more processors or processing units 510, memory 520, storage device 530, one or more communication units 540, one or more input devices 550, and one or more output devices 560. The processing unit 510 may be a real or virtual processor and may be capable of performing various processes according to programs stored in the memory 520. In a multiprocessor system, a plurality of processing units execute computer executable instructions in parallel to improve the parallel processing capability of the electronic device 500.

The electronic device 500 typically comprises a plurality of computer storage media. Such media may be any available media that is accessible to the electronic device 500, including, but not limited to, volatile and non-volatile media, removable and non-removable media. The memory 520 may be a volatile memory (e.g., register, cache, random access memory (RAM)), a non-volatile memory (e.g., read-only memory (ROM), electrically erasable programmable read-only memory (EEPROM), flash memory), or some combination thereof. The storage device 530 may be a removable or non-removable medium, and may include a machine-readable medium such as a flash drive, a magnetic disk, or any other medium that may be used to store information and/or data and that may be accessed within the electronic device 500.

The electronic device 500 may further comprise additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may comprise a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Accordingly, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not shown), such as storage devices, display devices, etc., as needed through the communication unit 540, with one or more devices that enable a user to interact with the electronic device 500, or with any device (e.g., network card, modem, etc.) that enables the electronic device 500 to communicate with one or more other electronic devices. Such communication may be performed via an input/output (I/O) interface (not shown).

According to an example implementation of the present disclosure, a computer-readable storage medium is provided, on which computer-executable instructions are stored, wherein the computer-executable instructions are executed by a processor to implement the above-described method. According to an example implementation of the present disclosure, there is also provided a computer program product, which is tangibly stored on a non-transitory computer-readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowchart and/or block diagrams, and combinations of blocks in the flowchart and/or block diagrams, can be implemented by computer-readable program instructions.

These computer-readable program instructions may be provided to a processing unit of a general purpose computer, special purpose computer, or other programmable data processing apparatus to produce a machine, such that the instructions, when executed by the processing unit of the computer or other programmable data processing apparatus, produce means for implementing the functions/acts specified in one or more blocks of the flowchart and/or block diagram. These computer-readable program instructions may also be stored in a computer-readable storage medium. These instructions can direct a computer, programmable data processing apparatus, and/or other devices to function in a particular manner, such that the computer-readable medium storing the instructions comprises an article of manufacture, which includes instructions that implement various aspects of the functions/acts specified in one or more blocks of the flowchart and/or block diagram.

The computer readable program instructions may be loaded onto a computer, other programmable data processing apparatus, or other devices, causing a series of operational steps to be performed on a computer, other programmable data processing apparatus, or other devices, to produce a computer implemented process, such that the instructions which execute on the computer, other programmable data processing apparatus, or other devices implement the functions/acts specified in one or more blocks of the flowchart and/or block diagram.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, a program segment, or a portion of instructions which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart, and combinations of blocks in the block diagrams and/or flowchart, can be implemented by special purpose hardware-based systems that perform the specified functions or acts, or combinations of special purpose hardware and computer instructions.

Having described implementations of the disclosure above, the foregoing description is illustrative, not exhaustive, and is not limited to the implementations disclosed. Many modifications and variations will be apparent to those of ordinary skill in the art without departing from the scope and spirit of the implementations described. The selection of terms used herein is intended to best explain the principles of the implementations, the practical application, or improvements to technologies in the market, or to enable others of ordinary skill in the art to understand the implementations disclosed herein.

1. A method for creating a workflow, comprising:
adding a first node to a node connection graph in response to a received edit operation;
obtaining configuration information associated with the first node, the configuration information at least indicating a set of nodes corresponding to a loop process; and
creating a target workflow based on the node connection graph to enable a loop execution of a processing procedure corresponding to the set of nodes in response to triggering of the first node during runtime of the target workflow.

2. The method of claim 1, wherein adding the first node to the node connection graph in response to the received edit operation comprises:
adding the first node to the node connection graph in response to a selection of a target interface element in a plurality of interface elements, the target interface element corresponding to a loop node, the plurality of interface elements corresponding to a plurality of node types.

3. The method of claim 1, wherein obtaining the configuration information associated with the first node comprises:
presenting a canvas component associated with the first node; and
determining, via the canvas component, the set of nodes corresponding to the loop process.

4. The method of claim 1, wherein obtaining the configuration information associated with the first node further comprises:
configuring a loop control parameter associated with the loop process via a first input control associated with the first node, the loop control parameter indicating an end condition of the loop process.

5. The method of claim 4, wherein configuring the loop control parameter associated with the loop process via the first input control associated with the first node comprises:
configuring an array object associated with the loop process such that the loop process is associated with a length of the array object.

6. The method of claim 5, wherein configuring the array object associated with the loop process comprises:
configuring the array object by referencing a second node associated with the first node.

7. The method of claim 1, wherein obtaining the configuration information associated with the first node further comprises:
configuring a global variable for the loop process via a second input control associated with the first node, the global variable supporting one or more of access or update by the set of nodes.

8. The method of claim 7, wherein configuring the global variable for the loop process via the second input control associated with the first node comprises:
configuring the global variable via the second input control by referencing a third node associated with the first node; or
configuring the global variable via the second input control, an initial value of the global variable determined based on a user input.

9. The method of claim 1, wherein the set of nodes comprises:
a setup node for setting a value of a predetermined variable associated with the loop process; or
an exit node for triggering to exit the loop process.

10. The method of claim 9, wherein input information of the exit node indicates a condition to exit the loop process.

11. The method of claim 1, further comprising:
receiving a request for debugging the target workflow;
providing, in association with a target node, a plurality of viewing entries corresponding to a plurality of rounds of execution of the processing procedure, the target node being the first node or one of the set of nodes; and
in response to a selection of a target viewing entry in the plurality of viewing entries, presenting debugging information associated with a target round of execution of the processing procedure and the target node, the target round corresponding to the target viewing entry.

12. An electronic device, comprising:
at least one processing unit; and
at least one memory coupled to the at least one processing unit and storing instructions for execution by the at least one processing unit that, when executed by the at least one processing unit, cause the electronic device to perform operations comprising:
adding a first node to a node connection graph in response to a received edit operation;
obtaining configuration information associated with the first node, the configuration information at least indicating a set of nodes corresponding to a loop process; and
creating a target workflow based on the node connection graph to enable a loop execution of a processing procedure corresponding to the set of nodes in response to triggering of the first node during runtime of the target workflow.

13. The electronic device of claim 12, wherein adding the first node to the node connection graph in response to the received edit operation comprises:
adding the first node to the node connection graph in response to a selection of a target interface element in a plurality of interface elements, the target interface element corresponding to a loop node, the plurality of interface elements corresponding to a plurality of node types.

14. The electronic device of claim 12, wherein obtaining the configuration information associated with the first node comprises:
presenting a canvas component associated with the first node; and
determining, via the canvas component, the set of nodes corresponding to the loop process.

15. The electronic device of claim 12, wherein obtaining the configuration information associated with the first node further comprises:
configuring a loop control parameter associated with the loop process via a first input control associated with the first node, the loop control parameter indicating an end condition of the loop process.

16. The electronic device of claim 12, wherein obtaining the configuration information associated with the first node further comprises:
configuring a global variable for the loop process via a second input control associated with the first node, the global variable supporting one or more of access or update by the set of nodes.

17. The electronic device of claim 12, wherein the set of nodes comprises:
a setup node for setting a value of a predetermined variable associated with the loop process; or
an exit node for triggering to exit the loop process.

18. The electronic device of claim 12, wherein the operations further comprise:
receiving a request for debugging the target workflow;
providing, in association with a target node, a plurality of viewing entries corresponding to a plurality of rounds of execution of the processing procedure, the target node being the first node or one of the set of nodes; and
in response to a selection of a target viewing entry in the plurality of viewing entries, presenting debugging information associated with a target round of execution of the processing procedure and the target node, the target round corresponding to the target viewing entry.

19. A non-transitory computer readable storage medium storing one or more instructions executable by a computer system to perform operations comprising:
adding a first node to a node connection graph in response to a received edit operation;
obtaining configuration information associated with the first node, the configuration information at least indicating a set of nodes corresponding to a loop process; and
creating a target workflow based on the node connection graph to enable a loop execution of a processing procedure corresponding to the set of nodes in response to triggering of the first node during runtime of the target workflow.

20. The non-transitory computer readable storage medium of claim 19, wherein adding the first node to the node connection graph in response to the received edit operation comprises:
adding the first node to the node connection graph in response to a selection of a target interface element in a plurality of interface elements, the target interface element corresponding to a loop node, the plurality of interface elements corresponding to a plurality of node types.
